(19) United States
(12) Patent Application Publication
(10) Pub. No.: US 2007/0018372 A1
(43) Pub. Date: Jan. 25, 2007

(54) CLAMPING MECHANISM

(75) Inventor: Ke Sun, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,757

(22) Filed: Apr. 28, 2006

(30) Foreign Application Priority Data
Jul. 22, 2005 (CN) 200510036144.3

(51) Int. Cl. B25B 1/14

(52) U.S. Cl. 269/228

(57) ABSTRACT

A clamping mechanism includes a catch, a lever, and a rigid bar. The catch is fixed on an object. The catch includes a base, a projection formed on the base, and a stop plate arranged adjacent to the projection. The lever is fixed on another object. The lever includes a tab and a base. The tab is pivotally connected with the base. One end of the rigid bar is connected with the lever, and the other end of the rigid bar engages the projection of the catch. Manipulation of the tab allows the rigid bar to engage or disengage from the catch.

### FIELD OF THE INVENTION

The present invention relates to a clamping mechanism, and more particularly to a clamping mechanism for releasably connecting two objects.

### DESCRIPTION OF RELATED ART

Typically, a clamping mechanism for releasably connecting two objects, as shown in FIG. 4, includes a catch 40 mounted to one object such as a workpiece in an assembly line, and a rigid bar 50 and a lever 60 mounted on another object such as a workbench. The catch 40 includes a base 41 and a projection 45. A plurality of positioning holes 43 is defined in the base 41, and a plurality of screws is provided to extend through the positioning holes 43 to fix the catch 40 to the workpiece. One end of the rigid bar 50 connects the lever 60, and the other end of the rigid bar 50 engages the projection 45 of the catch 40, thereby the workpiece and the workbench are latched together. However, when pulling the lever 60, tension in the rigid bar 50 as it is disengaged from the catch 40 may cause the lever 60 to release with enough force to damage the clamping mechanism and hurt an operator. Furthermore, even with the rigid bar 50 disengaged, the workpiece and the workbench usually remain so close together making it awkward to get a good grip on the workpiece to remove it and replace it with another.

What is needed, therefore, is a clamping mechanism which can be operated safely and easily.

### SUMMARY OF THE INVENTION

An exemplary clamping mechanism includes a catch, a lever, and a rigid bar. The catch is fixed on an object. The catch includes a base, a projection formed on the base, and a stop plate arranged adjacent to the projection. The lever is fixed on another object. The lever includes a tab and a base. The tab is pivotally connected with the base. One end of the rigid bar is connected with the lever, and the other end of the rigid bar engages the projection of the catch. Manipulation of the tab allows the rigid bar to engage or disengage from the catch.

Other advantages and novel features will become more apparent from the following detailed description of a preferred embodiment when taken in conjunction with the accompanying drawings, in which:

### BRIEF DESCRIPTION OF THE DRAWINGS

FIG. 1 is an assembled view of a clamping mechanism in accordance with a preferred embodiment of the present invention, and the clamping mechanism includes a catch, a rigid bar, and a lever;

FIG. 2 showing the catch of FIG. 1 from another aspect;

FIG. 3 is a schematic, side view of the clamping mechanism of FIG. 1, showing the rigid bar released from the catch; and

FIG. 4 is an assembled view of a conventional clamping mechanism.

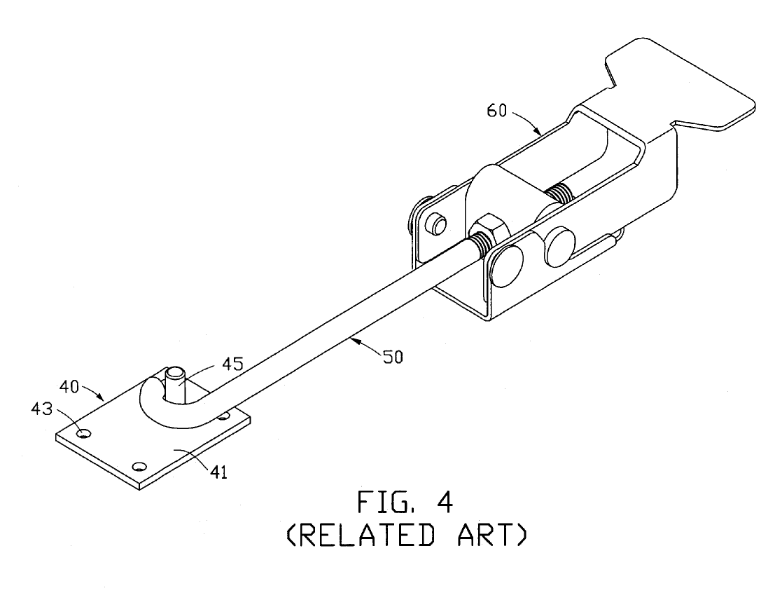

### DETAILED DESCRIPTION OF THE INVENTION

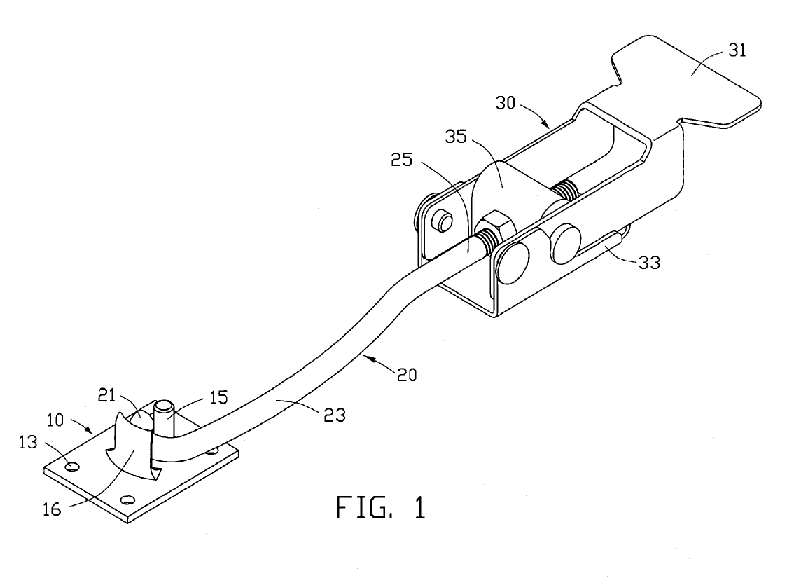

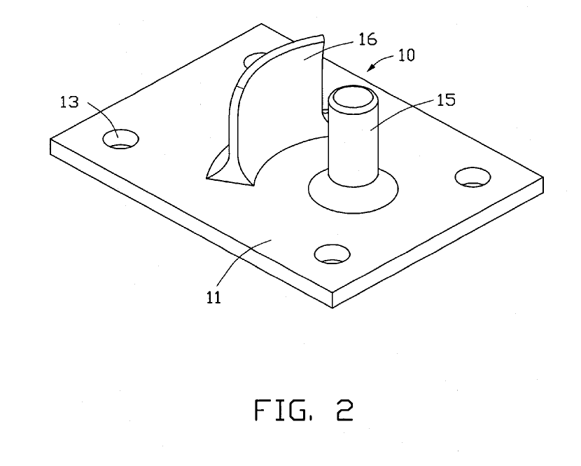

Referring to FIGS. 1 and 2, a clamping mechanism for connecting two objects is provided in accordance with a preferred embodiment of the present invention. The clamping mechanism includes a catch 10, a rigid bar 20, and a lever 30.

The catch 10 includes a base 11 defining a plurality of positioning holes 13 therein, a columnar projection 15 is formed from the base 10, and a curved stop plate 16 is formed from the base 10 adjacent to the projection 15.

The rigid bar 20 includes an arcuate connecting portion 23, a hook 21 formed from one end of the connecting portion 23, and a threaded fixing portion 25 formed from the other end of the connecting portion 23.

The lever 30 includes a tab 31, a retaining portion 35, and a base 33. The tab 31 is pivotally connected with the base 33, and the retaining portion 35 is rotatably fixed to the tab 31.

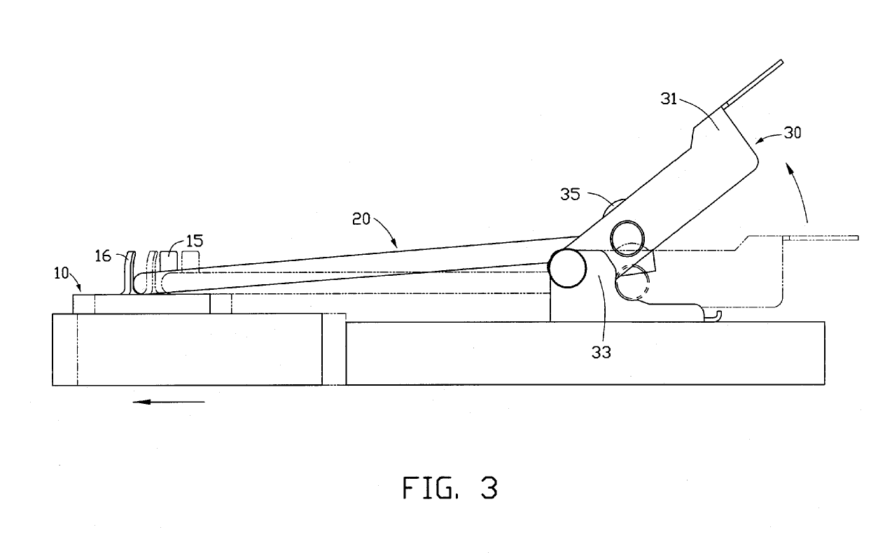

Referring also to FIG. 3, in assembly, the catch 10 is mounted on an object such as a workpiece in an assembly line, via a plurality of screws extending through the positioning holes 13 of the base 11 of the catch 10 and engaging in the workpiece. The base 33 of the lever 30 is mounted on another object such as a workbench, with the fixing portion 25 of the rigid bar 20 screwed into the retaining portion 35 of the lever 30.

When using the clamping mechanism, the tab 31 of the lever 30 is pulled up, and the hook 21 of the rigid bar 20 is placed between the projection 15 and the stop plate 16 of the catch 10. Then the tab 31 is pushed down, the rotated tab 31 pulls the rigid bar 20 towards the lever 30, and the hook 21 of the rigid bar 20 engages the projection 15 of the catch 10 tightly, thereby the workpiece and the workbench are clamped together.

To detach the workpiece from the workbench, the tab 31 of the lever 30 is pulled up, and the tab 31 pushes the rigid bar 20 towards the catch 10. The hook 21 of the rigid bar 20 disengages the projection 15 of the catch 10 and engages with the stop plate 16. The rigid bar 20 pushes the stop plate 16 away from the lever 30, and the workpiece is separated a predetermined distance from the workbench thereby forming a space therebetween. The predetermined distance is established when building the clamping mechanism by adjusting where the rigid bar 20 connects to the tab 31. With the rigid bar 20 lifted, the hook 21 is disengaged from the catch 10, and the workpiece can be easily removed by inserting a hand or a tool in the space between the workpiece and the workbench. In this process, the hook 21 of the rigid bar 20 strikes against the stop plate 16 when the tab 31 is pulled up, which prevents the tab 31 from being released with too much force thereby protecting the clamping mechanism from damage and an operator from harm.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A clamping mechanism comprising:
a catch comprising a base fixed on an object, a projection formed on the base, and a stop plate arranged adjacent to the projection;
a lever comprising a base fixed on another object and a tab pivotally connected with the base; and
a rigid bar with one end connected with the lever, and the other end engaging the projection of the catch, the rigid bar disengaged from the projection and pushing the stop plate thereafter by driving the tab.

2. The clamping mechanism as claimed in claim 1, wherein the rigid bar comprises a hook to engage the projection of the catch.

3. The clamping mechanism as claimed in claim 2, wherein the rigid bar further comprises a fixing portion, a retaining portion rotatably fixed on the tab, and the fixing portion connected with the retaining portion.

4. The clamping mechanism as claimed in claim 3, wherein an arcuate connecting portion is formed between the hook and the fixing portion.

5. The clamping mechanism as claimed in claim 1, wherein the projection is a cylinder.

6. The clamping mechanism as claimed in claim 1, wherein the stop plate is curved.

7. The clamping mechanism as claimed in claim 1, wherein the tab is rotated along a first direction, and the rigid bar pushes the catch moving along a second direction, and the second direction is perpendicular to the first direction.

8. A clamping mechanism comprising:
a catch comprising a base fixed on an object, and a stop plate formed on the base;
a lever comprising a base fixed on another object, and a tab movably attached to the base; and
a rigid bar with one end releasably engaging with the catch, and the other end connected with the lever, the rigid bar pushing the stop plate of the catch and detaching the objects when driving the lever.

9. The clamping mechanism as claimed in claim 8, wherein the catch further comprises a projection formed on the base, and the rigid bar comprises a hook to engage the projection of the catch.

10. The clamping mechanism as claimed in claim 9, wherein the projection is a cylinder.

11. The clamping mechanism as claimed in claim 8, wherein a retaining portion is rotatably fixed on the tab, and the rigid bar further comprises a fixing portion connected with the retaining portion.

12. The clamping mechanism as claimed in claim 11, wherein an arcuate connecting portion is formed between the hook and the fixing portion.

13. The clamping mechanism as claimed in claim 8, wherein the stop plate is curved.
